(19) United States
(12) Patent Application Publication
(10) Pub. No.: US 2024/0015542 A1
(43) Pub. Date: Jan. 11, 2024

(54) Flexible Interruption For L1 Measurement In Mobile Communications

(71) Applicant: MediaTek Singapore Pte. Ltd., Singapore (SG)

(72) Inventors: Waseem Hazim Ozan Ozan, Cambridge (GB); Tsang-Wei Yu, Hsinchu City (TW)

(21) Appl. No.: 18/208,750

(22) Filed: Jun. 12, 2023

Related U.S. Application Data
(60) Provisional application No. 63/367,920, filed on Jul. 8, 2022.

(51) Int. Cl. H04W 24/08; H04W 24/10

(52) U.S. Cl. CPC H04W 24/08; H04W 24/10

(57) ABSTRACT

Examples pertaining to flexible interruption for layer 1 (L1) measurement in mobile communications are described. A user equipment (UE) reports to a network a need for an interruption in communications between the UE and the network. The UE then performs a measurement of one or more resources during the interruption.

### CROSS REFERENCE TO RELATED PATENT APPLICATION(S)

The present disclosure is part of a non-provisional application claiming the priority benefit of U.S. Patent Application No. 63/367,920, filed 8 Jul. 2022, the content of which herein being incorporated by reference in its entirety.

### TECHNICAL FIELD

The present disclosure is generally related to mobile communications and, more particularly, to flexible interruption for layer 1) measurement in mobile communications.

### BACKGROUND

Unless otherwise indicated herein, approaches described in this section are not prior art to the claims listed below and are not admitted as prior art by inclusion in this section.

In wireless communications, such as mobile communications under the 3^{rd} Generation Partnership Project (3GPP) standards including 5^{th} Generation (5G) New Radio (NR) and 4^{th} Generation (4G) Evolved Packet Service (EPS), a user equipment (UE) may, when configured by a network, perform certain L1 measurements for a serving cell, such as a primary cell (PCell), primary secondary cell (PSCell) or secondary cell (SCell), on resources configured for L1 measurements within an active bandwidth part (BWP). At current time, there is no UE behavior defined in the 3GPP specification for synchronization signal block (SSB)-based L1 measurements outside the UE's active BWP. In some scenarios, when the SSB is outside the BWP, then the UE needs to keep its radio frequency (RF) BWP sufficiently large in order to cover both the BWP and the SSB without the need for RF re-tune. However, this comes at the cost of high power consumption for the UE. One possible solution could be that the network configures the UE with a measurement gap so that the UE could measure the SSB outside its active BWP. However, this may affect data transmission and reception to result in lower throughput. Therefore, there is a need for a solution of flexible interruption for L1 measurement in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is propose schemes, concepts, designs, systems, methods and apparatus pertaining to flexible interruption for L1 measurement in mobile communications. It is believed that the above-described issue(s) would be avoided or otherwise alleviated by implementing one or more of the proposed schemes described herein.

In one aspect, a method may involve a UE reporting to a network a need for an interruption in communications between the UE and the network. The method may also involve the UE performing a measurement of one or more resources during the interruption.

In another aspect, an apparatus may include a transceiver and a processor coupled to the transceiver. The transceiver may be configured to communicate wirelessly. The processor may report, via the transceiver, to a network a need for an interruption in communications between the UE and the network. The processor may also perform, via the transceiver, a measurement of one or more resources during the interruption.

It is noteworthy that, although description provided herein may be in the context of certain radio access technologies, networks and network topologies such as 5^{th} Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram of an example scenario in which various proposed solutions and schemes in accordance with the present disclosure may be implemented.

FIG. 3 is a block diagram of an example communication system in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to flexible interruption for L1 measurement in mobile communications. According to the present disclosure, a number of possible solutions may be implemented separately or jointly. That is, although these possible solutions may be described below separately, two or more of these possible solutions may be implemented in one combination or another.

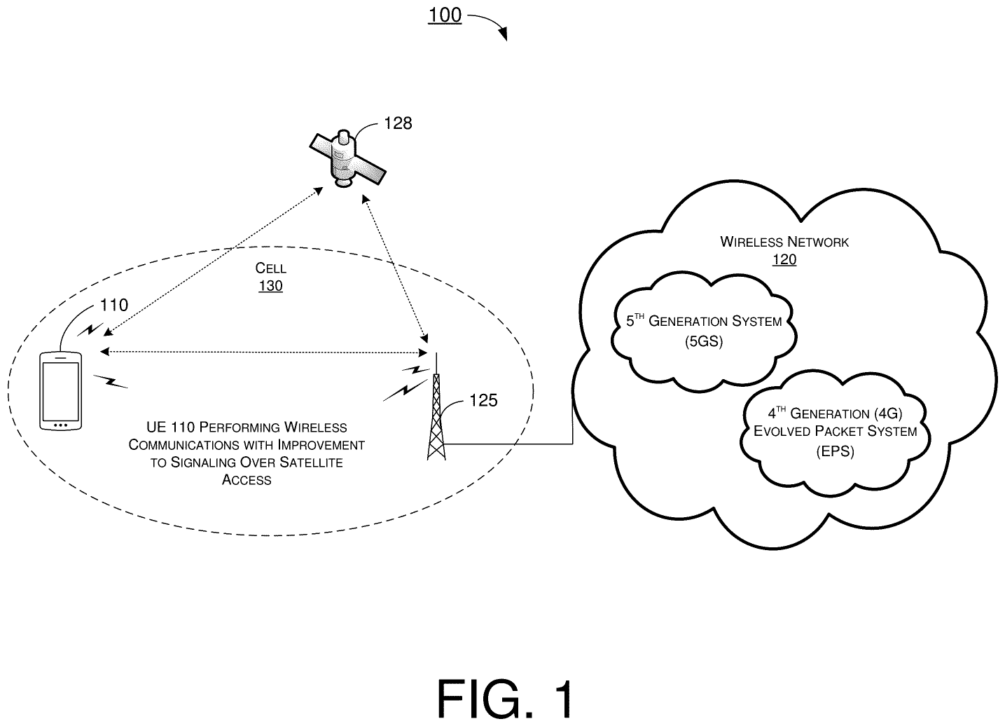

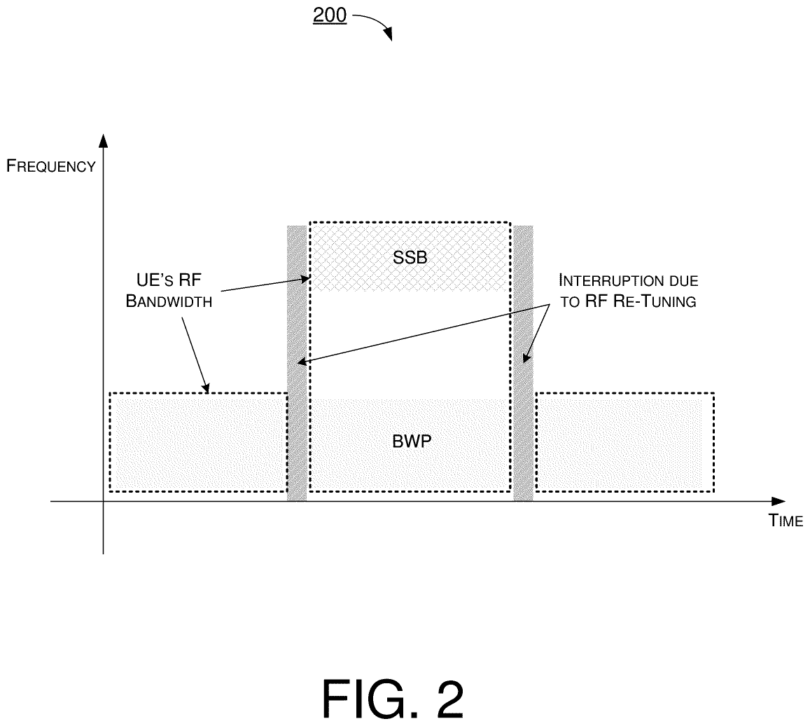

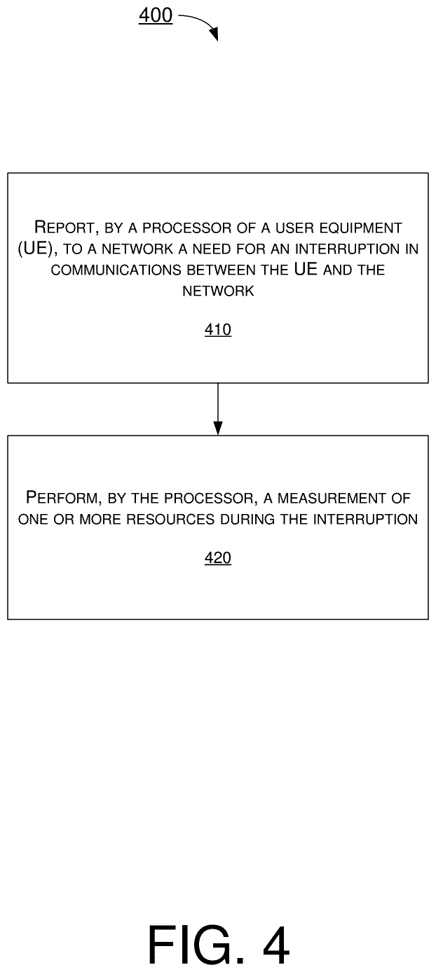

FIG. 1 illustrates an example network environment 100 in which various solutions and schemes in accordance with the present disclosure may be implemented. FIG. 2˜FIG. 4 illustrate examples of implementation of various proposed schemes in network environment 100 in accordance with the present disclosure. The following description of various proposed schemes is provided with reference to FIG. 1˜FIG. 4.

Referring to FIG. 1, network environment 100 may involve a UE 110 and a wireless network 120, which may include a 5^{th} Generation System (5GS) (and, optionally, an EPS). Depending on channel condition, availability and/or other factor(s), UE 110 may be in wireless communication with wireless network 120 via one or more terrestrial network nodes (e.g., base station(s) such as eNB, gNB and/or transmission/reception point (TRP)) and/or one or more non-terrestrial network nodes (e.g., satellite(s)). For simplicity in illustration and without limiting the scope of the present disclosure, UE 110 may be associated with or otherwise in communication with a cell 130 corresponding to a terrestrial network node 125 (e.g., gNB, eNB or TRP) and/or a non-terrestrial network node 128 (e.g., satellite) of wireless network 120. In network environment 100, UE 110 and wireless network 120 may implement various schemes pertaining to flexible interruption for L1 measurement in mobile communications in accordance with the present disclosure, as described below. It is noteworthy that, while the various proposed schemes may be individually or separately described below, in actual implementations each of the proposed schemes may be utilized individually or separately. Alternatively, some or all of the proposed schemes may be utilized jointly.

FIG. 2 illustrates an example scenario 200 in which various proposed solutions and schemes in accordance with the present disclosure may be implemented. Referring to FIG. 2, when configured by network 120, UE 110 may perform one or more L1 measurements for a serving cell, including PCell, PSCell or SCell, on resources configured for L1 measurements within or outside an active BWP of UE 110. In case of performing L1 measurement(s) outside the active BWP, UE 110 may or may not report a need for interruption in downlink (DL) transmission from and/or uplink (UL) transmission to network 120. The L1 measurements may include, for example, L1 reference signal received power (L1-RSRP), L1 reference signal received quality (L1-RSRQ), L1 signal to interference and noise ratio (L1-SINR), radio link monitoring (RLM), beam failure detection (BFD) and candidate beam detection (CBD). In some implementations, when an SSB transmitted by the serving cell is within the active BWP of UE 110, UE 110 may report no gap and/or no-network controlled small gap (no-NCSG) to network 120, as there is no need of an interruption or any time gap for RF re-tuning by UE 110. Alternatively, or additionally, when the SSB is outside the active BWP, UE 110 may report a need for gap(s) or NCSG to network 120, as UE 110 needs interruption(s) in DL/UL transmission from/to network 110. As shown in FIG. 2, with interruptions in transmission by network 120 before and after L1 measurements based on the SSB in a frequency band outside the active BWP of UE 110, gaps in the time domain in which there is no DL transmission from or UL transmission to network 120 allow UE 110 to perform RF re-tuning before and after performing the L1 measurements based on the SSB outside the active BWP.

In view of the above, one of ordinary skill in the art would appreciate that a reporting mechanism under the proposed schemes in accordance with the present disclosure may enable UE 110 to report the need for interruption to measure resources outside its active BWP, with the interruption being a small gap (e.g., short period in time) during which UE 110 is not expected to perform reception or transmission with network 120. Under the proposed schemes, UE 110 may perform L1 measurements for a serving cell on the resources configured by network 120 for L1 measurements outside the active BWP where UE 110 is to report the need for interruption when necessary (e.g., when UE 110 is aware of any upcoming transmission or reception with network 120 that would prohibit UE 110 to perform RF re-tuning in time in order to perform L1 measurements outside the active BWP). For instance, UE 110 may send a report to network 120 to indicate the need of interruption for UE 110 to perform RF re-tuning (e.g., to enlarge the active bandwidth of UE 110 to cover the resources on which L1 measurements are to be performed) to perform L1 measurements, such as L1-RSRP, L1-SINR, L1-RSRQ, and/or measurements for RLM, BFD and/or CBD. The L1 measurements may be performed for serving cells, including PCell, PSCell and/or Scell. Under the proposed schemes, UE 110 may not need to report to network 120 (for no gap or no interruption) when the resources (e.g., SSB) are within the active BWP of UE 110. When he resources (e.g., SSB) are outside the active BWP of UE 110, UE 110 may report a need for gap/interruption to network 120. Alternatively, UE 110 may not report the need in case that UE 110 determines there may be sufficient time for RF re-tuning based on known or scheduled reception and/or transmission with network 120. In some implementations, UE 110 may send the report to network 120 after radio resource control (RRC) re-configuration and/or downlink control information (DCI) signaling and/or medium access control (MAC) control element (CE). In some implementations, existing reporting capability of layer 3 (L3) may be extended for L1 measurement(s) for reporting without or with a new UE capability of UE 110.

### Illustrative Implementations

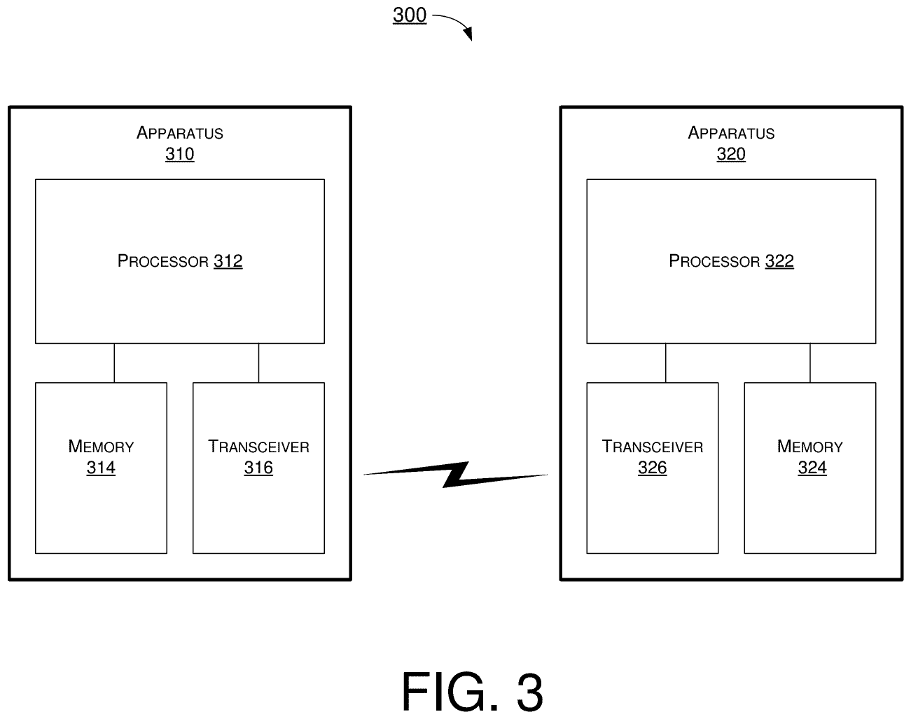

FIG. 3 illustrates an example communication system 300 having at least an example apparatus 310 and an example apparatus 320 in accordance with an implementation of the present disclosure. Each of apparatus 310 and apparatus 320 may perform various functions to implement schemes, techniques, processes and methods described herein pertaining to flexible interruption for L1 measurement in mobile communications, including the various schemes described above with respect to various proposed designs, concepts, schemes, systems and methods described above, including network environment 100, as well as processes described below.

Each of apparatus 310 and apparatus 320 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 310 and apparatus 320 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 310 and apparatus 320 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 310 and apparatus 320 may be implemented in a smart thermostat, a smart fridge, a smart door lock, a wireless speaker or a home control center. When implemented in or as a network apparatus, apparatus 310 and/or apparatus 320 may be implemented in an eNodeB in an LTE, LTE-Advanced or LTE-Advanced Pro network or in a gNB or TRP in a 5G network, an NR network or an IoT network.

In some implementations, each of apparatus 310 and apparatus 320 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 310 and apparatus 320 may be implemented in or as a network apparatus or a UE. Each of apparatus 310 and apparatus 320 may include at least some of those components shown in FIG. 3 such as a processor 312 and a processor 322, respectively, for example. Each of apparatus 310 and apparatus 320 may further include one or more other components not pertinent to the proposed scheme of the present disclosure (e.g., internal power supply, display device and/or user interface device), and, thus, such component(s) of apparatus 310 and apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC or RISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including those pertaining to flexible interruption for L1 measurement in mobile communications in accordance with various implementations of the present disclosure.

In some implementations, apparatus 310 may also include a transceiver 316 coupled to processor 312. Transceiver 316 may be capable of wirelessly transmitting and receiving data. In some implementations, transceiver 316 may be capable of wirelessly communicating with different types of wireless networks of different radio access technologies (RATs). In some implementations, transceiver 316 may be equipped with a plurality of antenna ports (not shown) such as, for example, four antenna ports. That is, transceiver 316 may be equipped with multiple transmit antennas and multiple receive antennas for multiple-input multiple-output (MIMO) wireless communications. In some implementations, apparatus 320 may also include a transceiver 326 coupled to processor 322. Transceiver 326 may include a transceiver capable of wirelessly transmitting and receiving data. In some implementations, transceiver 326 may be capable of wirelessly communicating with different types of UEs/wireless networks of different RATs. In some implementations, transceiver 326 may be equipped with a plurality of antenna ports (not shown) such as, for example, four antenna ports. That is, transceiver 326 may be equipped with multiple transmit antennas and multiple receive antennas for MIMO wireless communications.

In some implementations, apparatus 310 may further include a memory 314 coupled to processor 312 and capable of being accessed by processor 312 and storing data therein. In some implementations, apparatus 320 may further include a memory 324 coupled to processor 322 and capable of being accessed by processor 322 and storing data therein. Each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively, or additionally, each of memory 314 and memory 324 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 314 and memory 324 may include a UICC.

Each of apparatus 310 and apparatus 320 may be a communication entity capable of communicating with each other using various proposed schemes in accordance with the present disclosure. For illustrative purposes and without limitation, a description of capabilities of apparatus 310, as a UE (e.g., UE 110), and apparatus 320, as a network node (e.g., terrestrial network node 125 or non-terrestrial network node 128) of a wireless network (e.g., wireless network 120), is provided below.

Under certain proposed schemes in accordance with the present disclosure with respect to flexible interruption for L1 measurement in mobile communications, processor 312 of apparatus 310, implemented in or as a UE (e.g., UE 110), may report, via transceiver 316, to a network (e.g., network 120 via apparatus 320 as network node 125 or non-terrestrial network node 128) a need for an interruption in communications between the UE and the network. Moreover, processor 312 may perform, via transceiver 316, a measurement of one or more resources during the interruption.

In some implementations, in performing the measurement, processor 312 may perform a L1 measurement on the one or more resources (e.g., SSB) outside an active BWP of the UE. In some implementations, in performing the measurement, processor 312 may further perform RF re-turning during the interruption to enlarge a bandwidth of the UE to cover the one or more resources outside the active BWP. In some implementations, in performing the measurement, processor 312 may perform L1 measurement with respect to a serving cell, which may include a PCell, a PSCell and/or a SCell. In some implementations, the L1 measurement may include a measurement of at least one of L1-RSRP, L1-RSRQ and L1-SINR. Alternatively, or additionally, the L1 measurement may include a measurement related to at least one of RLM, BFD and CBD.

In some implementations, in reporting, processor 312 may transmit a report after a RRC re-configuration or a DCI or a MAC CE. Alternatively, or additionally, in reporting, processor 312 may report based on a reporting capability of L3 that is extended for L1 measurement.

In some implementations, prior to the reporting, processor 312 may determine whether there is the need for the interruption in communications between the UE and the network. In some implementations, in determining, processor 312 may determine that: (a) there is no need for the interruption responsive to the one or more resources being within an active BWP of the UE; or (b) determining that there is the need for the interruption responsive to the one or more resources being outside the active BWP of the UE.

### Illustrative Processes

FIG. 4 illustrates an example process 400 in accordance with an implementation of the present disclosure. Process 400 may represent an aspect of implementing various proposed designs, concepts, schemes, systems and methods described above, whether partially or entirely, including those described above. More specifically, process 400 may represent an aspect of the proposed concepts and schemes pertaining to flexible interruption for L1 measurement in mobile communications. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. Furthermore, one or more of the blocks/sub-blocks of process 400 may be executed iteratively. Process 400 may be implemented by or in apparatus 310 and apparatus 320 as well as any variations thereof. Solely for illustrative purposes and without limiting the scope, process 400 is described below in the context of apparatus 310 as a UE (e.g., UE 110) and apparatus 320 as a communication entity such as a network node or base station (e.g., terrestrial network node 125 or non-terrestrial network node 128) of a network (e.g., wireless network 120). Process 400 may begin at block 410.

At 410, process 400 may involve processor 312 of apparatus 310, implemented in or as a UE (e.g., UE 110), reporting, via transceiver 316, to a network (e.g., network 120 via apparatus 320 as network node 125 or non-terrestrial network node 128) a need for an interruption in communications between the UE and the network. Process 400 may proceed from 410 to 420.

At 420, process 400 may involve processor 312 performing, via transceiver 316, a measurement of one or more resources during the interruption.

In some implementations, in performing the measurement, process 400 may involve processor 312 performing a L1 measurement on the one or more resources (e.g., SSB) outside an active BWP of the UE. In some implementations, in performing the measurement, process 400 may further involve processor 312 performing RF re-turning during the interruption to enlarge a bandwidth of the UE to cover the one or more resources outside the active BWP. In some implementations, in performing the measurement, process 400 may involve processor 312 performing L1 measurement with respect to a serving cell, which may include a PCell, a PSCell and/or a SCell. In some implementations, the L1 measurement may include a measurement of at least one of L1-RSRP, L1-RSRQ and L1-SINR. Alternatively, or additionally, the L1 measurement may include a measurement related to at least one of RLM, BFD and CBD.

In some implementations, in reporting, process 400 may involve processor 312 transmitting a report after a RRC re-configuration or a DCI or a MAC CE. Alternatively, or additionally, in reporting, process 400 may involve processor 312 reporting based on a reporting capability of L3 that is extended for L1 measurement.

In some implementations, prior to the reporting, process 400 may involve processor 312 determining whether there is the need for the interruption in communications between the UE and the network. In some implementations, in determining, process 400 may involve processor 312 determining that: (a) there is no need for the interruption responsive to the one or more resources being within an active BWP of the UE; or (b) determining that there is the need for the interruption responsive to the one or more resources being outside the active BWP of the UE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
reporting, by a processor of a user equipment (UE), to a network a need for an interruption in communications between the UE and the network; and
performing, by the processor, a measurement of one or more resources during the interruption.

2. The method of claim 1, wherein the performing of the measurement comprises performing a layer 1 (L1) measurement on the one or more resources outside an active bandwidth part (BWP) of the UE.

3. The method of claim 2, wherein the performing of the measurement further comprises performing radio frequency (RF) re-turning during the interruption to enlarge a bandwidth of the UE to cover the one or more resources outside the active BWP.

4. The method of claim 2, wherein the performing of the L1 measurement comprises performing the L1 measurement with respect to a serving cell, and wherein the serving cell comprises a primary cell (PCell), a primary secondary cell (PSCell) or a secondary cell (SCell).

5. The method of claim 2, wherein the L1 measurement comprises a measurement of at least one of L1 reference signal received power (L1-RSRP), L1 reference signal received quality (L1-RSRQ) and L1 signal to interference and noise ratio (L1-SINR).

6. The method of claim 2, wherein the L1 measurement comprises a measurement related to at least one of radio link monitoring (RLM), beam failure detection (BFD) and candidate beam detection (CBD).

7. The method of claim 1, wherein the reporting comprises transmitting a report after a radio resource control (RRC) re-configuration or a downlink control information (DCI) or a medium access control (MAC) control element (CE).

8. The method of claim 1, wherein the reporting comprises reporting based on a reporting capability of layer 3 (L3) that is extended for layer 1 (L1) measurement.

9. The method of claim 1, prior to the reporting, further comprising:
determining, by the processor, whether there is the need for the interruption in communications between the UE and the network.

10. The method of claim 9, wherein the determining comprises:
determining that there is no need for the interruption responsive to the one or more resources being within an active bandwidth part (BWP) of the UE; or
determining that there is the need for the interruption responsive to the one or more resources being outside the active BWP of the UE.

11. An apparatus implementable in a user equipment (UE), comprising:
a transceiver configured to communicate wirelessly; and
a processor coupled to the transceiver and configured to perform, via the transceiver, operations comprising:
reporting, via the transceiver, to a network a need for an interruption in communications between the UE and the network; and
performing, via the transceiver, a measurement of one or more resources during the interruption.

12. The apparatus of claim 11, wherein the performing of the measurement comprises performing a layer 1 (L1) measurement on the one or more resources outside an active bandwidth part (BWP) of the UE.

13. The apparatus of claim 12, wherein the performing of the measurement further comprises performing radio frequency (RF) re-turning during the interruption to enlarge a bandwidth of the UE to cover the one or more resources outside the active BWP.

14. The apparatus of claim 12, wherein the performing of the L1 measurement comprises performing the L1 measurement with respect to a serving cell, and wherein the serving cell comprises a primary cell (PCell), a primary secondary cell (PSCell) or a secondary cell (SCell).

15. The apparatus of claim 12, wherein the L1 measurement comprises a measurement of at least one of L1 reference signal received power (L1-RSRP), L1 reference signal received quality (L1-RSRQ) and L1 signal to interference and noise ratio (L1-SINR).

16. The apparatus of claim 12, wherein the L1 measurement comprises a measurement related to at least one of radio link monitoring (RLM), beam failure detection (BFD) and candidate beam detection (CBD).

17. The apparatus of claim 11, wherein the reporting comprises transmitting a report after a radio resource control (RRC) re-configuration or a downlink control information (DCI) or a medium access control (MAC) control element (CE).

18. The apparatus of claim 11, wherein the reporting comprises reporting based on a reporting capability of layer 3 (L3) that is extended for layer 1 (L1) measurement.

19. The apparatus of claim 11, prior to the reporting, the processor is further configured to perform operations comprising:
determining whether there is the need for the interruption in communications between the UE and the network.

20. The apparatus of claim 19, wherein the determining comprises:
determining that there is no need for the interruption responsive to the one or more resources being within an active bandwidth part (BWP) of the UE; or
determining that there is the need for the interruption responsive to the one or more resources being outside the active BWP of the UE.
